(19) United States
(12) Patent Application Publication
(10) Pub. No.: US 2008/0158222 A1
(43) Pub. Date: Jul. 3, 2008

(54) Apparatus and Methods for Selecting and Customizing Avatars for Interactive Kiosks

(75) Inventors: Renxiang Li, Lake Zurich, IL (US); Dongge Li, Hoffman Estates, IL (US); Yun Fu, Urbana, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/618,405

(22) Filed: Dec. 29, 2006

(51) Int. Cl. G06T 1/00

(52) U.S. Cl. 345/418

(57) ABSTRACT

A method of generating an avatar for a user may include receiving image data of a user from a camera, generating feature vectors for a plurality of features of a user, associating the user with a likely user group selected from a number of defined user groups based on the feature vectors, and assigning an avatar based on the associated user group.

### TECHNICAL FIELD

The present invention is directed to the use of avatars at interactive kiosks. More particularly, the present invention is directed to methods and apparatus for selecting and customizing avatars based on visual appearance and gait analysis of a user.

### BACKGROUND

Interactive kiosks are becoming more and more prevalent in today's society. Conventional kiosks range from informative to transactional, including countless varieties of combinations thereof. Conventional kiosks typically include a keyboard, a trackball or mouse-type device, a touchscreen, and/or a card reader for paging through menus, inputting data, and completing transactions.

Given that a portion of the population prefers not to interact with a kiosk in an impersonal, computer-oriented environment, it may be desirable to provide a kiosk having a mechanism to personalize the interaction with users. For example, it may be desirable to provide a kiosk with an avatar for interacting with users. Motion of the avatar can be controlled so as to mimic human motions and behavior.

Still, avatars may not always attract new users because certain portions of the population may be reluctant to interact with other portions of the population with which they are uncomfortable. For example, a young, contemporary college student may not be inclined to interact with a kiosk having an avatar that mimics an older, traditional business man. It should be appreciated how every facet of an avatar's appearance can appeal to or offend a potential user. Features such as age, gender, race, hair length, glasses, piercings, tattoos, attire, gait, and other aspects of appearance can influence whether a user is more or less willing to interact with an avatar-based kiosk.

Some users may be more attracted to an interactive kiosk if the avatar has an appearance and/or behavior that reflects the general characteristics of a user. For example, a more youthful user may be more inclined to interact with a kiosk having a similarly youthful-looking avatar, and a more elderly person may be more inclined to interact with a kiosk having a similarly elderly-looking avatar. Thus, it may be desirable to provide a system and method for observing the appearance and/or behavior of a user prior to initiation of interaction with the kiosk and to select an avatar for interaction based on the observations.

### SUMMARY OF THE INVENTION

According to various aspects of the disclosure, a method of generating an avatar for a user may include receiving image data of a user from a camera, generating feature vectors for a plurality of features of a user, associating the user with a likely user group selected from a number of defined user groups based on the feature vectors, and assigning an avatar based on the associated user group.

In accordance with some aspects of the disclosure, an apparatus for avatar generation may comprise a video interface configured to receive image data of a user, and an avatar generation engine configured to receive the image data from the video interface, generate feature vectors for a plurality of features of a user, associate the user with a likely user group selected from a number of defined user groups based on the feature vectors, and assign an avatar based on the associated user group.

In various aspects of the disclosure, a method of incrementally training a user group classifier may comprise receiving image data of a user from a camera, generating an aggregate feature vector from a plurality of feature vectors associated with a plurality of features of a user, receiving personal information and/or personal preferences input by the user, and determining a target user group for the user based on the user input. The method may include associating the aggregate feature vector with the determined target user group and training a user group classifier based on the association of the aggregate feature vector with the determined target user group

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of a kiosk system having an avatar generation engine in accordance with a possible embodiment of the invention;

FIG. 2 is an exemplary flowchart illustrating one possible avatar generation process in accordance with one possible embodiment of the invention;

FIG. 3 illustrates a block diagram of exemplary modules of an avatar generation engine in accordance with a possible embodiment of the invention; and

FIG. 4 is an exemplary flowchart illustrating exemplary modules of an exemplary user group classifier module, as well as an exemplary flow of data in the user group classifier in accordance with one possible embodiment of the invention.

### DETAILED DESCRIPTION

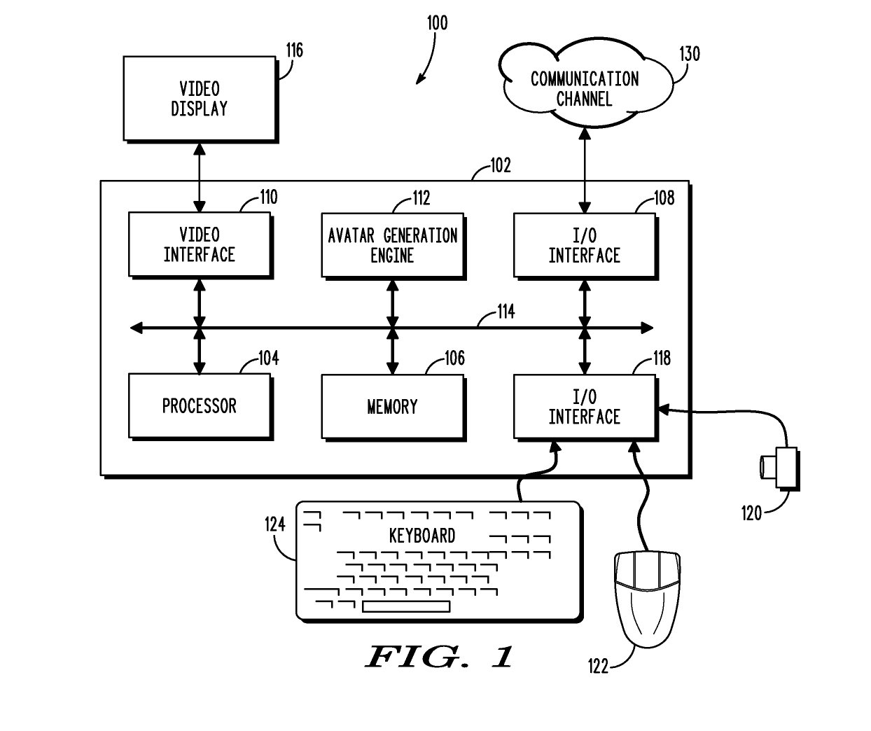

FIG. 1 illustrates a block diagram of an exemplary kiosk system 100 having an avatar generation engine 112 in accordance with a possible embodiment of the invention. Various embodiments of the disclosure may be implemented using a computer 102, such as, for example, a general-purpose computer, as shown in FIG. 1.

The kiosk system 100 may include the computer 102, a video display 116, and input devices 120, 122, 124. In addition, the kiosk system 100 can have any of a number of other output devices including line printers, laser printers, plotters, and other reproduction devices connected to the computer 102. The kiosk system 100 can be connected to one or more other computers via a communication interface 108 using an appropriate communication channel 130 such as a modem communications path, a computer network, or the like. The computer network may include a local area network (LAN), a wide area network (WAN), an Intranet, and/or the Internet.

The computer 102 may comprise a processor 104, a memory 106, input/output interfaces 108, 118, a video interface 110, an avatar generation engine 112, and a bus 114. Bus 114 may permit communication among the components of the computer 102.

Processor 104 may include at least one conventional processor or microprocessor that interprets and executes instructions. Memory 106 may be a random access memory (RAM) or another type of dynamic storage device that stores information and instructions for execution by processor 104. Memory 106 may also include a read-only memory (ROM) which may include a conventional ROM device or another type of static storage device that stores static information and instructions for processor 104.

The video interface 110 is connected to the video display 116 and provides video signals from the computer 102 for display on the video display 116. User input to operate the computer 102 can be provided by one or more input devices 120, 122, 124 via the input/output interface 118. For example, an operator can use the keyboard 124 and/or a pointing device such as the mouse 122 to provide input to the computer 102. In some aspects, the camera 120 may provide video data to the computer 102.

The kiosk system 100 and computer 102 may perform such functions in response to processor 104 by executing sequences of instructions contained in a computer-readable medium, such as, for example, memory 106. Such instructions may be read into memory 106 from another computer-readable medium, such as a storage device or from a separate device via communication interface 108.

The kiosk system 100 and computer 102 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the kiosk system 100 and computer 102. Generally, program modules include routine programs, objects, components, data structures, etc. that perform particular tasks or implement particular abstract data types. Moreover, those skilled in the art will appreciate that other embodiments of the invention may be practiced in computer environments with many types of communication equipment and computer system configurations, including cellular devices, mobile communication devices, personal computers, hand-held devices, multi-processor systems, microprocessor-based or programmable consumer electronics, and the like.

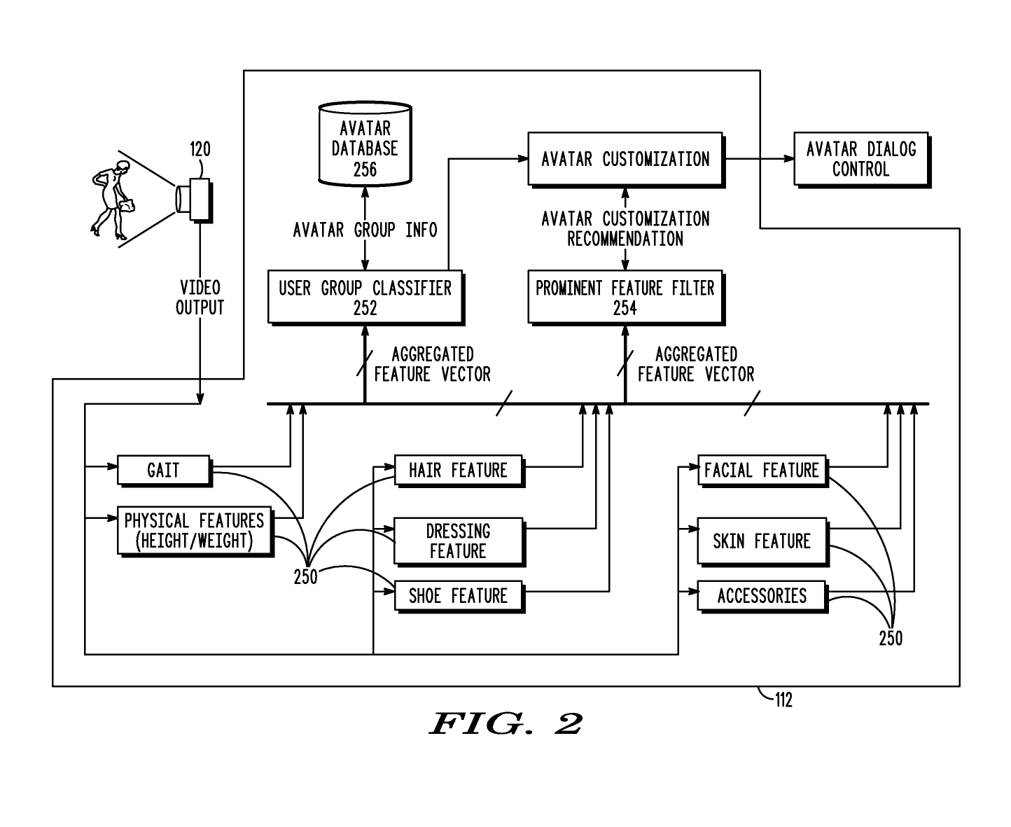

Referring now to FIG. 2, the block diagram illustrates exemplary modules of the avatar generation engine 112, as well as an exemplary flow of data in the avatar generation engine 112. The data flow begins with image data from the camera 120 being received by the avatar generation engine 112. The image data is then made available to the exemplary visual analysis modules 250.

As shown in FIG. 2, an exemplary avatar generation engine 112 may include visual analysis modules 250 for the following: gait, physical features (e.g., height and weight), age/gender, facial features, skin features, hair features, dressing features, accessories, and shoes. Each of the visual analysis modules 250 outputs a feature vector, which vectors may be combined by the avatar generation engine 112 to determine an aggregated feature vector representative of the user.

The gait module may observe step size and/or frequency, body tilt, or the like. The physical features module may perform height and weight estimation, for example, via a calibrated camera. The age/gender may determine whether a user is young, old, or middle based on determined thresholds, as well as the gender of the user.

The facial features module may observe iris color, emotion, a mustache, or the like, while the skin features module may observe skin tone. The hair features module may observe hair tone and texture, length of hair, and the like. The dressing features module may observe cloth tone and texture, amount of exposed skin area, t-shirts, jeans, suit, etc. The accessories module may observe glasses, piercings, tattoos, or the like, while the shoe module may differentiate between athletic, casual, and formal shoes.

The avatar generation module 112 may include a user group classifier module 252 and a prominent feature filter 254. The user group classifier module 252 receives the aggregated feature vector and determines, using pattern classification techniques such as nearest neighbor classification (K-means), a user group to which the user most likely belongs. The determination of the user group may be a selection among a number of user groups stored in an avatar database 256 along with at least one avatar representative of each user group. The number of user groups, as well as which group a given aggregate feature vector may associate to, can be modified dynamically as more information is gathered from users or as input by a system administrator.

The avatars representative of each user group may also be dynamically updated as more users are associated with each group. For example, if a certain percentage of users associated with a user group include the same prominent features, as determined by the prominent feature filter 254 (discussed below), the avatar associated with that user group may be modified to include that prominent feature. The avatars may also be updated from time to time by the system administrator to more accurately reflect the always-changing identity of each user group.

The prominent feature filter 254 also receives the aggregate feature vector. The prominent feature filter 254 is configured to determine prominent features of the user based on the aggregate feature vector representative of the image data from the camera 120. A number of agents can be designed to detect, for example, the unusual or distinguish features from the user, such as green hair, nose piercing, etc. The avatar generation engine 112 may be configured to customize the avatar selected by the user group classifier module 252 by adding the prominent features of the user identified by the prominent feature filter 254. The avatar generation engine 112 can then output the customized avatar to the display 116 of the kiosk system 100 for presentation to and interaction with the user.

For illustrative purposes, the avatar generation process of the avatar generation engine 112 will be described below in relation to the block diagrams shown in FIGS. 1 and 2.

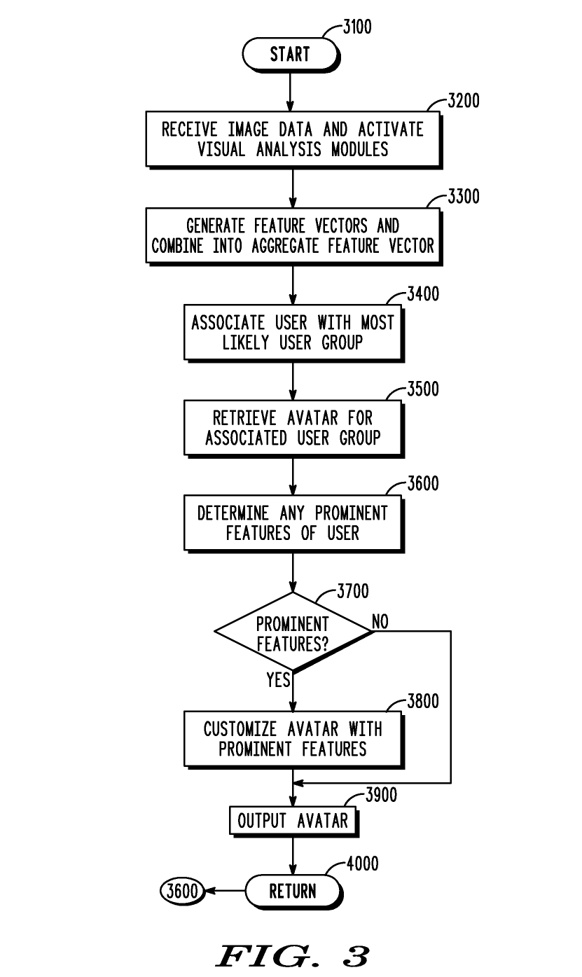

FIG. 3 is an exemplary flowchart illustrating some of the basic steps associated with an avatar generation process in accordance with a possible embodiment of the invention. The process begins at step 3100 and continues to step 3200 where the avatar generation engine 112 receives image data from the camera 120 and activates the visual analysis modules 250. It should be appreciated that the camera 120 may be configured to automatically detect an approaching user and begin collection of image data. Control then proceeds to step 3300.

In step 3300, the visual analysis modules 250 each generate a feature vector. It should be appreciated that the feature vector can be generated based on a single frame of image data or based on a series of frames of image data. One skilled in the art will recognize the benefit of considering at least a nominal number of frames when generating the feature vectors. The feature vectors are combined into an aggregate feature vector that is input to the user group classifier module 252.

The process continues to step 3400, where the user group classifier module 252 associates the user with a user group that is determined to be the most likely group for that user based on the aggregate feature vector. Control then continues to step 3500, where the avatar generation engine 112 retrieves the avatar for the associated user group from the database 256 of avatars and associates the retrieved avatar with the user. Control proceeds to step 3600.

Next, in step 3600, the prominent feature filter 254 determines whether the user displays any prominent features based on the aggregate feature vector compiled from the feature vectors of the feature analysis modules 250. The feature vectors, and thus the aggregate feature vector, may be continuously updated throughout this process. The process then goes to step 3700.

If, in step 3700, the avatar generation engine 112 determines that the user possesses one or more prominent features, control proceeds to step 3800. In step 3800, the avatar generation engine 112 customizes the user's avatar with prominent feature information recommended by the prominent feature filter 254. Control then goes to step 3900, where the customized avatar is output for user interaction, for example, via the display 116 of the kiosk system 100. Control then proceeds to step 4000, where control returns to step 3600.

If, in step 3700, the avatar generation engine 112 determines that the user does not possess one or more prominent features, control goes to step 3900 without customization to the retrieved avatar. In step 3900, the avatar is output for user interaction, and control goes to step 4000, where control returns to step 3600.

As the feature vectors and aggregate feature vector are continuously updated based on the latest frames of image data, the prominent feature filter 254 may determine, in step 3600, additional prominent features of the user that may be used to further customize the avatar in step 3700. It should be appreciated that, in some exemplary embodiments, the process of FIG. 3 can be configured such that when control reaches step 3800, the process ends, rather than returning to step 3600.

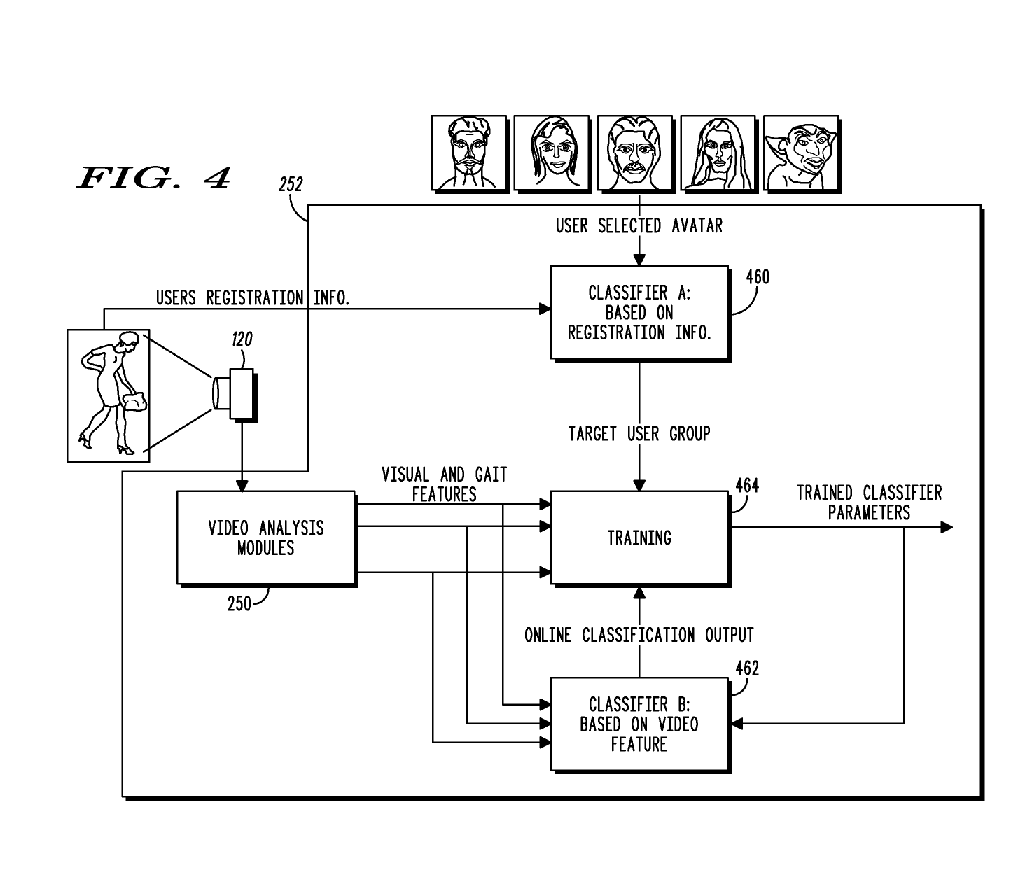

Referring now to FIG. 4, the block diagram illustrates exemplary modules of the user group classifier module 252, as well as an exemplary flow of data in the user group classifier 252. The data flow begins with image data from the camera 120 being received by the avatar generation engine 112. The image data is then made available to the exemplary visual analysis modules 250, where feature vectors and an aggregate feature vector are output. In addition, a user can input personal information, such as, for example, education, occupation, age, race, income, etc. According to some aspects, the user may also be able to select a preferred avatar. The user's personal information and/or avatar preference may be input via the mouse 122 or keyboard 124 associated with the kiosk system 100 or it may be input remotely, such as, for example, at a personal computer via an internet website or via a different kiosk in communication with the system 100 via the communication channel 130.

Classifier A 460 may be configured to determine a target user group for the user based on the inputted personal information and preferences. The training module 464 may be configured to attempt to associate the aggregated feature vector received from the video tracking input (e.g., camera 120) via the video analysis modules 250 with the target user group determined by classifier A 460. As a result of this association of information and video data, the training module 464 may provide the parameters for classifier B 462.

Classifier A 460 may be dedicated to offline training, such as, for example, via user registration information, and can therefore provide reliable user group classification. However, for a first time user, the user's personal information and preferences are not available. Thus, the user group classifier 252 may rely on classifier B 462 to provide a most likely user classification based solely on visual features received via the video analysis modules 250.

After a user is registered and new personal information and preferences are input, classifier B's determination may need to be slightly adjusted. This adjustment may be referred to as incremental online training. Again, the detailed user profile information and/or user preferences is given to classifier A 460. If the output of classifier A 460 differs from that of classifier B 462, then classifier B is adjusted accordingly towards the target user group determined by classifier A.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A method of generating an avatar for a user, comprising:
receiving image data of a user from a camera;
generating feature vectors for a plurality of features of a user;
associating the user with a likely user group selected from a number of defined user groups based on the feature vectors; and
assigning an avatar based on the associated user group.

2. The method of claim 1, further comprising combining the feature vectors into an aggregate feature vector, wherein the associating is based on the aggregate feature vector.

3. The method of claim 1, further comprising determining, based on the feature vectors, whether the user has a prominent feature.

4. The method of claim 3, further comprising:
when it is determined that the user has at least one prominent feature, customizing the assigned avatar to include the at least one prominent feature; and
outputting the customized avatar for user interaction.

5. The method of claim 3, further comprising, when it is determined that the user does not have at least one prominent feature, outputting the assigned avatar for user interaction.

6. The method of claim 3, further comprising updating the avatar associated with the likely user group based on the at least one prominent feature of the user.

7. The method of claim 1, further comprising detecting a user approaching the camera.

8. The method of claim 1, further comprising outputting the assigned avatar for user interaction.

9. An apparatus for avatar generation, comprising:
a video interface configured to receive image data of a user; and
an avatar generation engine configured to receive the image data from the video interface, generate feature vectors for a plurality of features of a user, associate the user with a likely user group selected from a number of defined user groups based on the feature vectors, and assign an avatar based on the associated user group.

10. The apparatus of claim 9, wherein the avatar generation engine is further configured to combine the feature vectors into an aggregate feature vector, wherein the associating is based on the aggregate feature vector.

11. The apparatus of claim 9, wherein the avatar generation engine is further configured to determine, based on the feature vectors, whether the user has at least one prominent feature.

12. The apparatus of claim 11, wherein, when it is determined that the user has at least one prominent feature, the avatar generation engine is further configured to customize the assigned avatar to include the at least one prominent feature and output the customized avatar for user interaction.

13. The apparatus of claim 11, wherein, when it is determined that the user does not have at least one prominent feature, the avatar generation engine is further configured to output the assigned avatar for user interaction.

14. The apparatus of claim 11, wherein the avatar generation engine is further configured to update the avatar associated with the likely user group based on the at least one prominent feature of the user.

15. The apparatus of claim 9, wherein the avatar generation engine is further configured to output the assigned avatar for user interaction.

16. The apparatus of claim 9, wherein the apparatus cooperates with a display to form a kiosk system, the display being configured to display the assigned avatar for user interaction.

17. The apparatus of claim 16, further comprising:
a camera configured to detect an approaching user, capture image data, and send the image data to the video interface;
a computer, the computer including the avatar generation engine and being configured to animate the avatar and to control communications between the avatar and the user; and
at least one input device configured to permit the user to interact with the displayed avatar via the computer.

18. A method of incrementally training a user group classifier, comprising:
receiving image data of a user from a camera;
generating an aggregate feature vector from a plurality of feature vectors associated with a plurality of features of a user;
receiving at least one of personal information and personal preferences input by the user;
determining a target user group for the user based on the user input;
associating the aggregate feature vector with the determined target user group; and
training a user group classifier based on the association of the aggregate feature vector with the determined target user group.

19. The method of claim 18, wherein the training comprises training the user group classifier to associate similar aggregate feature vectors of additional users with the determined target user group.

20. The method of claim 19, further comprising adjusting the user group classifier based on at least one of personal information and personal preferences input by additional users.
